(19) United States
(12) Patent Application Publication
(10) Pub. No.: US 2023/0386165 A1
(43) Pub. Date: Nov. 30, 2023

(54) INFORMATION PROCESSING DEVICE, RECORDING MEDIUM, AND INFORMATION PROCESSING METHOD

(71) Applicant: NEC Corporation, Tokyo (JP)

(72) Inventor: Naoto Yamaguchi, Tokyo (JP)

(73) Assignee: NEC Corporation, Tokyo (JP)

(21) Appl. No.: 18/200,946

(22) Filed: May 23, 2023

(30) Foreign Application Priority Data
May 31, 2022 (JP) 2022-089044

(51) Int. Cl. G06V 10/25; G06T 7/70

(52) U.S. Cl. CPC G06V 10/25; G06T 7/70; G06V 2201/07

(57) ABSTRACT

To enable a process in consideration of a third region obtained from a plurality of regions detected from an image. An information processing device includes an image acquisition unit that acquires an image, an object detection unit that detects a first region including a first object and a second region including a second object from the image, and a processing unit that performs a process related to the second object based on a third region obtained by the first region and the second region.

This application is based upon and claims the benefit of priority from Japanese Patent Application No. 2022-089044, filed on May 31, 2022, the disclosure of which is incorporated herein in its entirety by reference.

### TECHNICAL FIELD

The present disclosure relates to an information processing device, a recording medium, and an information processing method.

### BACKGROUND ART

A method of obtaining a region including an object for each object from an image including a plurality of objects and performing a process based on a relationship between the regions is known. For example, Patent Literature 1 (JP 2020-198053 A) discloses an information processing device that detects a region overlapping with an object and a region not overlapping with the object in a person and determines a certainty factor of a feature amount regarding an attribute grasped from each region.

### SUMMARY

Although the information processing device disclosed in JP 2020-198053 A focuses on a region overlapping with an object and a region not overlapping with the object in a person, there is room for further study on a method of processing information based on a third region obtained from a plurality of regions.

In view of the above-described problems, an object of the present disclosure is to provide an information processing device, a recording medium, and an information processing method capable of performing a process in consideration of a third region obtained from a plurality of regions detected from an image.

### BRIEF DESCRIPTION OF THE DRAWINGS

Exemplary features and advantages of the present invention will become apparent from the following detailed description when taken with the accompanying drawings in which:

FIG. 1 is a diagram illustrating a configuration of an information processing device according to the first example embodiment;

FIG. 2 is a flowchart illustrating a process performed by the information processing device according to the first example embodiment;

FIG. 3 is a diagram illustrating a configuration of an information processing device according to the second example embodiment;

FIG. 4A is a diagram for explaining a shape of a region including an object;

FIG. 4B is a diagram for explaining a shape of a region including an object;

FIG. 4C is a diagram for explaining a shape of a region including an object;

FIG. 5A is a diagram for explaining information obtained from a third region by a region analysis unit;

FIG. 5B is a diagram for explaining information obtained from the third region by the region analysis unit;

FIG. 5C is a diagram for explaining information obtained from the third region by the region analysis unit;

FIG. 6 is a diagram for explaining a divided third region;

FIG. 7 is a flowchart illustrating a process performed by the information processing device according to the second example embodiment;

FIG. 8 is a diagram illustrating a configuration of an information processing device according to the third example embodiment;

FIG. 9A is a diagram for describing a process of obtaining region information from a plurality of third regions;

FIG. 9B is a diagram for describing a process of obtaining region information from a plurality of third regions;

FIG. 10 is a flowchart illustrating a process performed by the information processing device of the third example embodiment;

FIG. 11 is a diagram illustrating a configuration of an information processing device of the fourth example embodiment;

FIG. 12A is a diagram for explaining a method of correcting region information;

FIG. 12B is a diagram for explaining a method of correcting region information;

FIG. 12C is a diagram for explaining a method of correcting region information;

FIG. 12D is a diagram for explaining a method of correcting region information;

FIG. 13 is a flowchart illustrating a process performed by an information processing device of the fourth example embodiment;

FIG. 14 is a diagram illustrating a configuration of an information processing device of the fifth example embodiment;

FIG. 15 is a flowchart illustrating a process performed by the information processing device of the fifth example embodiment;

FIG. 16A is a diagram for describing a usage example of the information processing device of the fifth example embodiment;

FIG. 16B is a diagram for describing a usage example of the information processing device of the fifth example embodiment;

FIG. 16C is a diagram for describing a usage example of the information processing device of the fifth example embodiment;

FIG. 16D is a diagram for describing a usage example of the information processing device of the fifth example embodiment;

FIG. 17 is a diagram illustrating a configuration of an information processing device of the sixth example embodiment;

FIG. 18 is a flowchart illustrating a process performed by the information processing device of the sixth example embodiment;

FIG. 19A is a diagram for describing a usage example of the information processing device of the sixth example embodiment;

FIG. 19B is a diagram for describing a usage example of the information processing device of the sixth example embodiment;

FIG. 19C is a diagram for describing a usage example of the information processing device of the sixth example embodiment;

FIG. 19D is a diagram for describing a usage example of the information processing device of the sixth example embodiment;

FIG. 20 is a diagram for describing another usage example of the information processing device of the sixth example embodiment; and

FIG. 21 is a diagram illustrating a configuration of a computer constituting an information processing device of the present disclosure.

### EXAMPLE EMBODIMENT

### First Example Embodiment

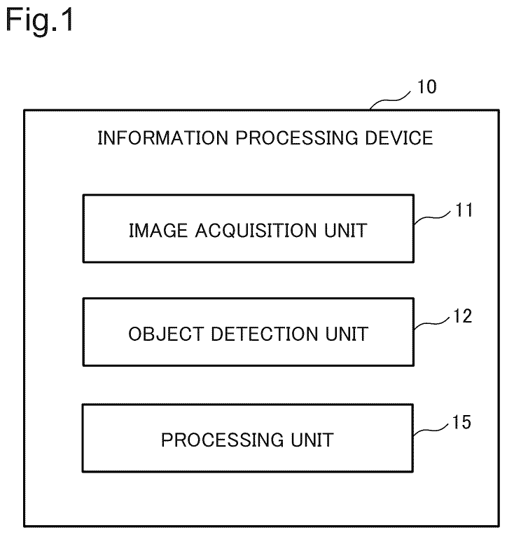

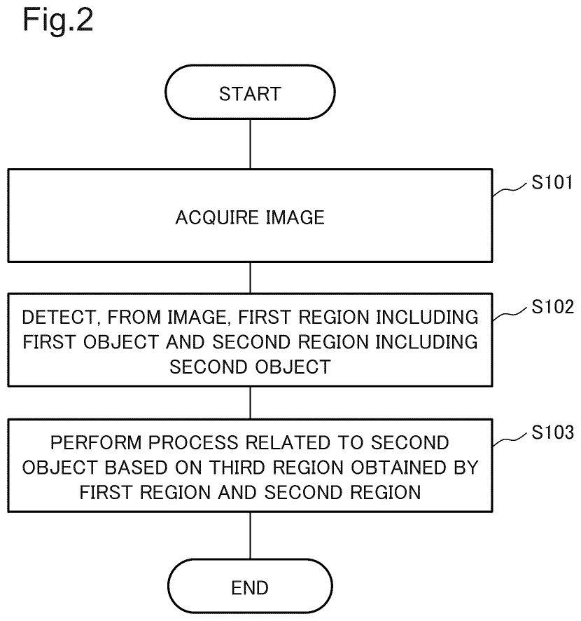

The first example embodiment of the present disclosure will be described with reference to FIGS. 1 and 2.

FIG. 1 is a block diagram illustrating a configuration of an information processing device 10 according to the first example embodiment. The information processing device 10 according to the present example embodiment includes an image acquisition unit 11, an object detection unit 12, and a processing unit 15.

The image acquisition unit 11 serves as an image acquisition means and acquires an image. The object detection unit 12 serves as an object detection means, and detects a first region including a first object and a second region including a second object from the acquired image. The first object is, for example, a person, an obstacle, a shield, or the like. The obstacle or the shield is, for example, a moving object or a building. The second object is a person different from the person detected as the first object or various objects carried by the person. The various objects carried by the person may include, for example, various objects classified as furniture, fruits, musical instruments, tools, instruments, and the like. The processing unit 15 serves as a processing means, and performs a process related to the second object based on a third region obtained by the first region and the second region. The third region is, for example, a region obtained by excluding a region in which the first region and the second region overlap each other, a region, of one region, overlapping with the other region, or the like. More specifically, it is a region, of the second region, obtained by excluding the first region. Examples of the process related to the second object include a process of identifying details of the second object, a process of making a notification related to the second object, and the like.

Next, an information processing method performed by the information processing device 10 according to the present example embodiment will be described with reference to a flowchart of FIG. 2. FIG. 2 is a flowchart illustrating a process performed by the information processing device 10 according to the first example embodiment.

First, the image acquisition unit 11 acquires an image (S101). Next, the object detection unit 12 detects a first region including the first object and a second region including the second object from the acquired image (S102). The processing unit 15 performs a process related to the second object based on a third region obtained by the first region and the second region. The third region is, for example, a region, of the second region, obtained by excluding a region overlapping the first region.

As described above, according to the information processing device 10 of the first example embodiment, the object detection unit 12 obtains the first region including the first object and the second region including the second object from the image. The processing unit 15 can perform a process related to the second object based on the third region obtained by the first region and the second region. As a result, it is possible to perform a process in consideration of the third region obtained from the plurality of regions detected from the image.

### Second Example Embodiment

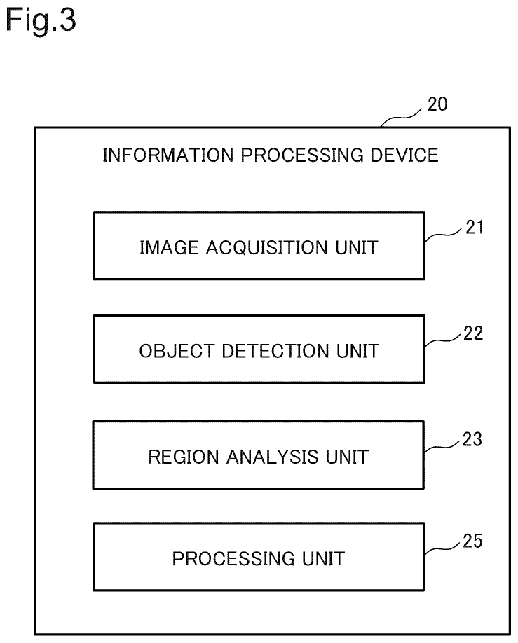

A second example embodiment in the present disclosure will be described with reference to FIGS. 3 to 8. The information processing device of the present example embodiment is different from that of the above-described first example embodiment in that it further includes a region analysis unit.

FIG. 3 is a block diagram illustrating a configuration of an information processing device 20 according to the second example embodiment. The information processing device 20 includes an image acquisition unit 21, an object detection unit 22, a region analysis unit 23, and a processing unit 25.

The image acquisition unit 21 acquires images from various devices. The various devices are, for example, an imaging device, a mobile terminal, a storage device, and the like. The imaging device is not limited to a monitoring camera that monitors a specific area, but may be a wearable camera that can be worn by a person, a drone, an in-vehicle camera, or the like. The mobile terminal may be a portable terminal such as a smartphone. The storage device may be a database, a cloud storage, or the like. Such various devices may be configured integrally with the information processing device 20.

The object detection unit 22 detects a first region including the first object and a second region including the second object from the image. The first object is, for example, a person, an obstacle, a shield, or the like. The obstacle or the shield is, for example, a moving object or a building. The second object is a person different from the person detected as the first object or various objects carried by the person. The various objects carried by the person may include, for example, various objects classified as furniture, fruits, musical instruments, tools, instruments, and the like.

The object detection unit 22 learns a feature amount of an object and detects a region including an object similar to the learned feature amount from an image. Examples of such a detection method include region based convolutional neural networks (R-CNN), You Look Only Onse (YOLO), a single shot multibox detector (SSD), and the like. The object detection unit 22 may implement the process of detecting the first region including the first object and the process of detecting the second region including the second object by different methods. The object detection unit 22 may be separately configured by a first detection unit that detects a first region including a first object and a second detection unit that detects a second region including a second object. Furthermore, the first detection unit and the second detection unit may be incorporated in different devices.

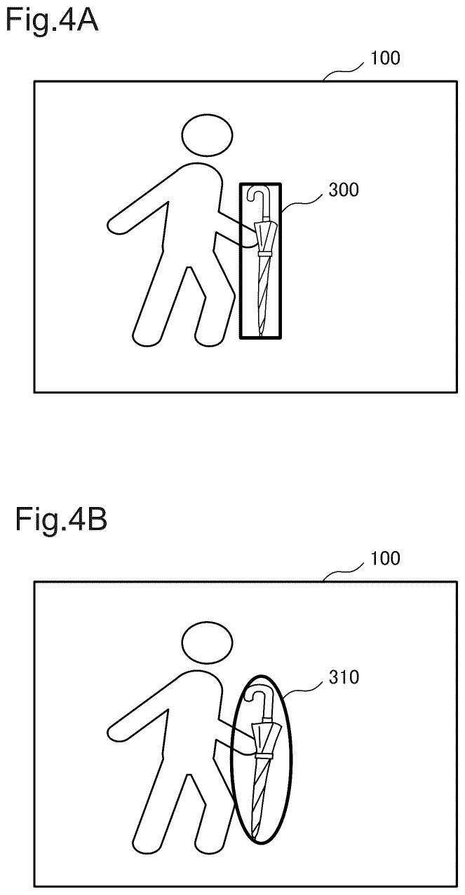

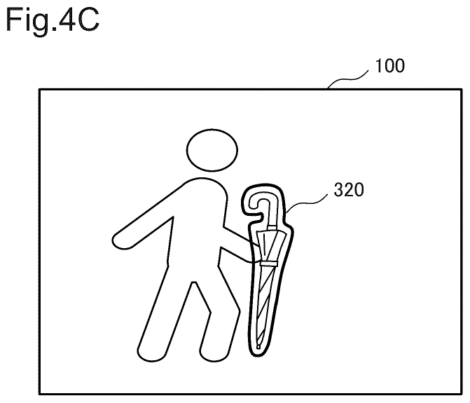

The object detection unit 22 may extract regions having various shapes for the region including the object. The shape of such a region will be described with reference to FIGS. 4A to 4C. FIGS. 4A to 4C are diagrams for explaining a shape of a region including an object. For example, as illustrated in FIG. 4A, the shape of the region including the object may be a rectangular region 300 surrounding the object appearing in an image 100. As illustrated in FIG. 4B, a circle 310 surrounding an object appearing in the image 100 may be used. Furthermore, as illustrated in FIG. 4C, the shape may be a shape 320 along the object appearing in the image 100.

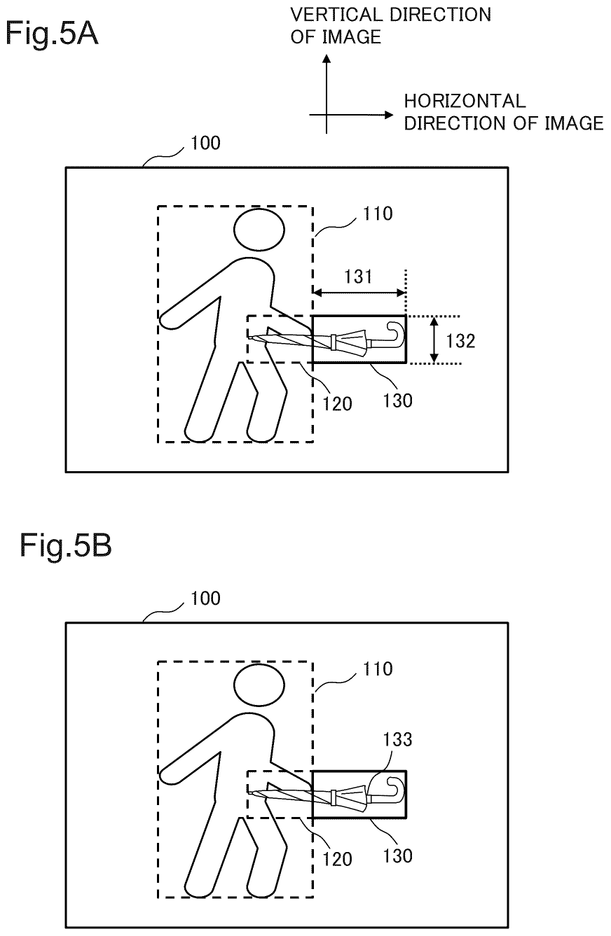

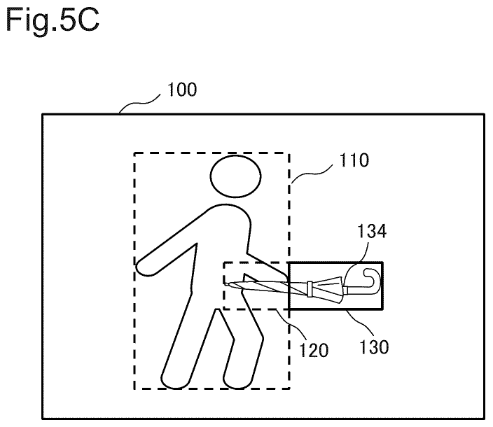

The region analysis unit 23 obtains region information from the third region obtained by the first region and the second region. The third region is, for example, a region obtained by excluding a region in which the first region and the second region overlap each other, a region, of one region, overlapping with the other region, or the like. More specifically, it is a region, of the second region, obtained by excluding a region overlapping the first region. The region information is information obtained from the shape of the third region and the position on the image. For example, it includes a length of the third region, an area of the third region, position information about the third region, and the like. Other than this, for example, the aspect ratio or the like of the third region may be obtained. The length of the third region, the area of the third region, and the position information about the third region will be described in detail with reference to FIGS. 5A to 5C. FIGS. 5A to 5C are diagrams for explaining region information obtained by the region analysis unit 23.

For example, as illustrated in FIG. 5A, the region analysis unit 23 obtains the length of a third region 130 from the third region 130 excluding a region overlapping with the first region 110 in a second region 120. The length of the third region 130 may include, for example, a first length 131 along a first direction in the third region 130. It may include a second length 132 along a second direction in the third region 130.

The first direction and the second direction may be determined based on, for example, the image 100. For example, a direction along the horizontal direction of the image 100 may be defined as the first direction, and a direction along the vertical direction of the image 100 may be defined as the second direction. Similarly, a direction along the vertical direction of the image 100 may be defined as the first direction, and a direction along the horizontal direction of the image 100 may be defined as the second direction. The second direction may be a direction orthogonal to the first direction with reference to the first direction. In FIG. 5A, the horizontal direction in image 100 is indicated as the first direction.

The first length 131 may be either the shortest length or the longest length among the lengths along the first direction obtained from the third region 130. Similarly, the second length may be either the shortest length or the longest length among the lengths 132 along the second direction.

For example, as illustrated in FIG. 5B, the region analysis unit 23 obtains an area 133 of the third region from the third region 130 excluding the region overlapping with the first region 110 in the second region 120.

For example, as illustrated in FIG. 5C, the region analysis unit 23 obtains position information 134 of the third region from the third region 130 excluding the region overlapping with the first region 110 in the second region 120. The position information 134 of the third region is, for example, a position of the third region 130 on the image. The position on the image may be represented by, for example, two-dimensional coordinates.

The position information 134 of the third region may represent a relative positional relationship with the first object in consideration of the position of the first object on the image, the orientation of the first object, and the like. For example, it may represent a positional relationship such as “located right of the first object” based on the position of the first object on the image. Further, it may represent a positional relationship including a direction such as “located in front of the first object” based on the orientation of the first object.

In order to represent the relative positional relationship with the first object, for example, the position of the third region with respect to the first object may be obtained by the following method. For example, the position of the third region with respect to the first object may be determined by comparing the position of the first object on the image with the position of the third region 130 on the image. The position of the third region with respect to the first object may be obtained by comparing the orientation of the first object, the position of the first object on the image, and the position of the third region 130 on the image. The orientation of the first object may be obtained using, for example, a known posture estimation technique. Alternatively, it may be identified by obtaining the rotation angle of the first object.

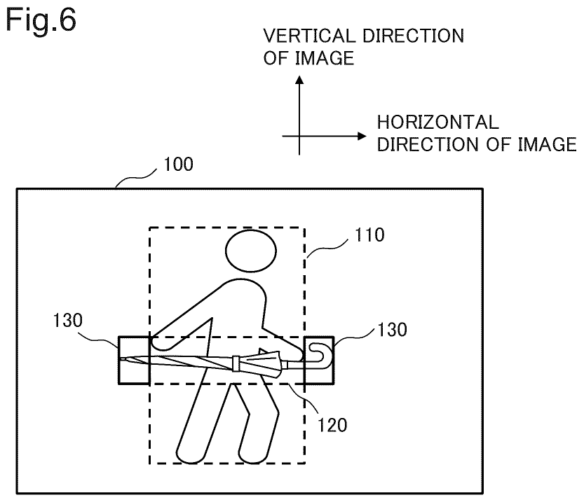

As illustrated in FIG. 6, for example, the third region 130 may be divided into a plurality of regions in such a way as to sandwich the first region 110 therebetween. FIG. 6 is a diagram for explaining the divided third region 130. According to the third region 130 illustrated in FIG. 6, the third region 130 exists right of the first region 110. The third region 130 also exists left of the first region 110. As described above, when the third region 130 is divided into a plurality of regions, the region information may be obtained for each third region 130. Then, by adding them, they may be treated as the region information about the third region 130 in the image 100. Adding the region information is not limited to adding values such as a length and an area. For example, in a case where coordinates are handled as position information, each coordinate is held.

The processing unit 25 performs a process related to the second object based on the third region 130 obtained by the first region 110 and the second region 120. In a case where the region information obtained by the region analysis unit 23 satisfies a predetermined condition, the processing unit 25 may be configured to perform a process related to the second object. Examples of the process related to the second object include a process of identifying details of the second object, a process of making a notification related to the second object, and the like.

The predetermined condition is, for example, that the first length 131 in the third region 130 is longer than a threshold value, that the second length 132 in the third region 130 is longer than a threshold value, or the like. The predetermined condition may further include that the area 133 of the third region is larger than the threshold value. Further, the predetermined condition may include that the third region 130 is present at a predetermined position. The predetermined position may be, for example, a specific position on the image, or may be represented by a relative positional relationship with the first object, such as “the third region 130 is located in front of the first object”. The threshold value may be a common value or may be different for each predetermined condition.

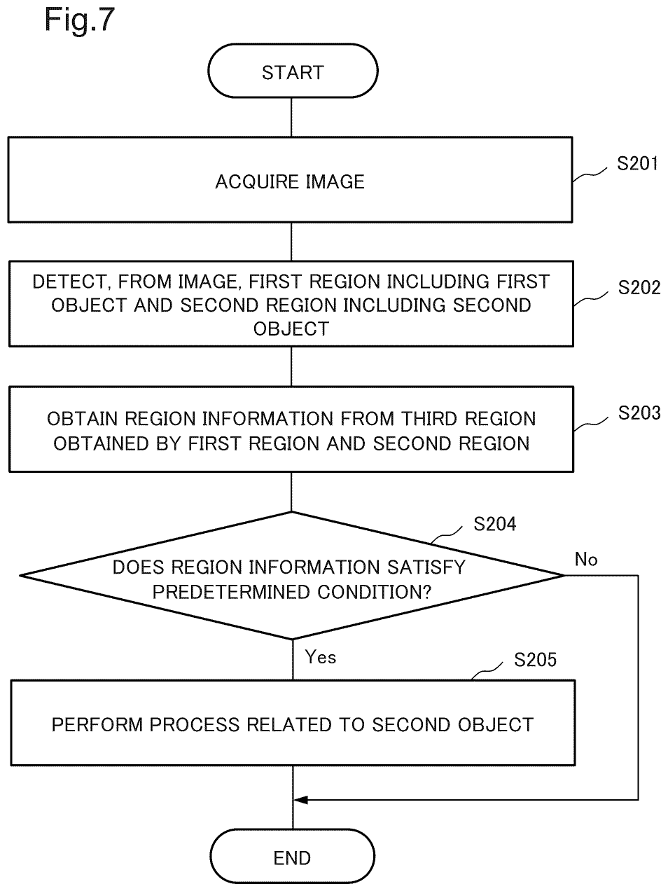

A series of processes performed by the information processing device 20 of the present example embodiment will be described with reference to a flowchart of FIG. 7. FIG. 7 is a flowchart illustrating a process performed by the information processing device 20 according to the second example embodiment.

First, the image acquisition unit 21 acquires images from various devices (S201). Next, the object detection unit 22 detects the first region 110 including the first object and the second region 120 including the second object from the image acquired by the image acquisition unit 21 (S202).

Then, the region analysis unit 23 obtains region information from the third region 130 obtained by the first region 110 and the second region 120 (S203). The third region 130 is, for example, a region obtained by excluding a region overlapping with the first region 110 in the second region 120. The region information is, for example, the first length 131 in the third region 130. The first length 131 is, for example, the longest length among the lengths in the direction along the horizontal direction of the image 100 in the third region 130. In the subsequent processing, the information processing device 20 determines whether the region information satisfies a predetermined condition (S204). The predetermined condition is, for example, that the first length 131 in the third region 130 is larger than a threshold value.

Then, in a case where it is determined in S204 that the region information satisfies the predetermined condition, the processing unit 25 performs a process related to the second object (S205), and the flow ends. Examples of the process related to the second object include a process of identifying details of the second object, a process of making a notification related to the second object, and the like. On the other hand, in a case where it is determined in S204 that the region information does not satisfy the predetermined condition, the flow ends.

In the flowchart illustrated in FIG. 7, it is determined in S204 whether the region information satisfies the predetermined condition, but it may be determined whether the region information satisfies the predetermined condition different from S204. Further, a plurality of predetermined conditions may be determined. Then, the process related to the second object may be performed according to the determination result. Furthermore, the process related to the second object may be performed in a case where the predetermined condition is not satisfied.

As described above, according to the information processing device 20 of the present example embodiment, the region analysis unit 23 can obtain the region information about the third region 130. The processing unit 25 can perform a process related to the second object based on the region information. This makes it possible to accurately perform a process related to the second object.

The second example embodiment in the present disclosure is not limited to the above-described aspect, but may be configured as follows, for example.

For the object detected by the object detection unit 22, the information processing device 20 may be configured to leave the execution result of the process for the second object in the history for each detected first object. The history may include that the process related to the second object is not performed. According to such a configuration, it is possible to suppress repetition of the process related to the second object for the object that has already been processed. It is also possible to give priority to the first object that has not been processed with respect to the second object.

The information processing device 20 may limit the object candidates to be detected by the object detection unit 22. In a case where the candidates of the object to be detected are limited, for example, the limitation may be achieved by setting a priority.

The priority may be set according to, for example, the type of the object to be detected or the size of the object. For example, the priority may be set for a rough category such as “person”, “moving object”, or “building”. Alternatively, the priority may be set for a finer category such as “adult”, “car”, or “hospital”. The priority may be achieved, for example, by performing weighting for each category. Similarly, weighting may be performed according to the size of the object appearing in the image 100. For example, the larger the object, the higher the weight is set. The process of limiting the object candidates to be detected may be performed only when the first object is detected. Alternatively, the process may be performed only when the second object is detected. According to such a configuration, since the type of the object to be detected from the image can be limited, the process related to the second object can be efficiently performed.

### Third Example Embodiment

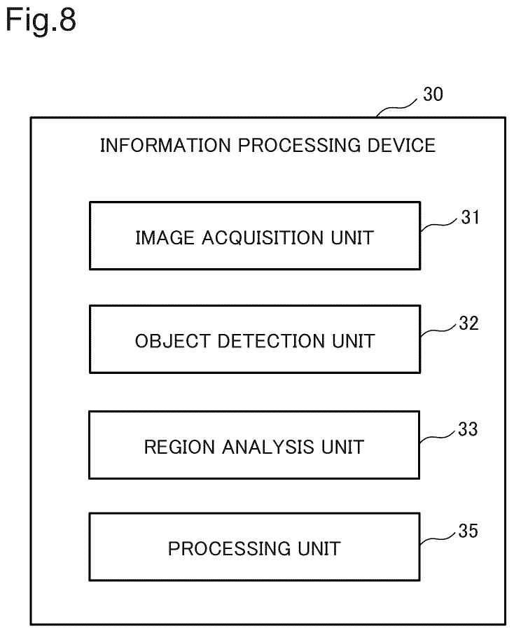

The third example embodiment of the present disclosure will be described with reference to FIGS. 8 to 10. The information processing device according to the present example embodiment is different from that according to the second example embodiment described above in that it includes a region analysis unit 33 to be described later instead of the region analysis unit 23.

FIG. 8 is a block diagram illustrating a configuration of an information processing device 30 of the present example embodiment. The information processing device 30 includes an image acquisition unit 31, an object detection unit 32, the region analysis unit 33, and a processing unit 35.

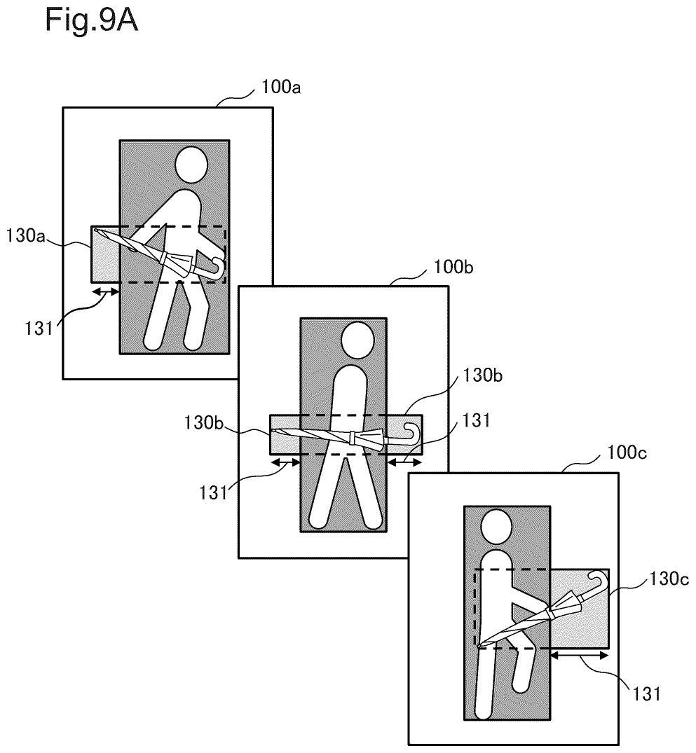

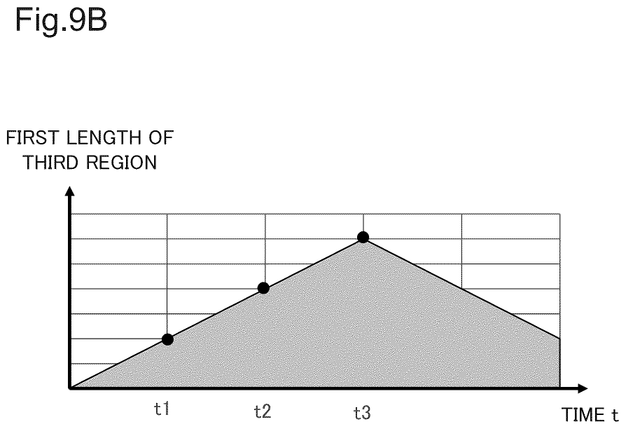

The region analysis unit 33 obtains region information based on the plurality of third regions 130 obtained from the plurality of images in addition to the functions of the region analysis unit 23 of the second example embodiment described above. The process of obtaining region information from the plurality of third regions 130 will be described with reference to FIGS. 9A and 9B. FIGS. 9A and 9B are diagrams for describing a process of obtaining region information from the plurality of third regions 130.

As illustrated in FIG. 9A, the region analysis unit 33 obtains the first length 131 of the third region 130a obtained from an image 100a. It obtains the first length 131 of the third region 130b obtained from an image 100b. In the image 100b, since the third region 130b is divided into a plurality of regions, the first length 131 is obtained for each third region 130b. Then, the first length 131 in the image 100b is obtained by adding the first lengths 131 obtained from the plurality of third regions 130b. Further, it obtains the first length 131 for the third region 130c obtained from an image 100c.

FIG. 9B illustrates a graph in which the horizontal axis represents time t and the vertical axis represents the first length of the third region. In this graph, the first length 131 obtained from an image 100a acquired at time t1, the first length 131 obtained from an image 100b acquired at time t2, and the first length 131 obtained from an image 100c acquired at time t3 are illustrated.

Then, the region analysis unit 33 obtains region information based on the plurality of first lengths 131 obtained in a certain period. For example, a value obtained by integrating a function determined by the first length 131 obtained at times t1 to t3 is obtained. Other than this, the region information may be obtained by adding, subtracting, or averaging the region information obtained from a plurality of respective images obtained within a certain period. Furthermore, instead of the certain period, the region information may be obtained from a certain number of images. Furthermore, the region information may be obtained from a certain number of third regions 130.

In FIGS. 9A and 9B, the first length 131 in the third region 130 is described as an example, but the present invention is not limited thereto, and various pieces of region information described in the above-described example embodiment may be obtained from a plurality of images.

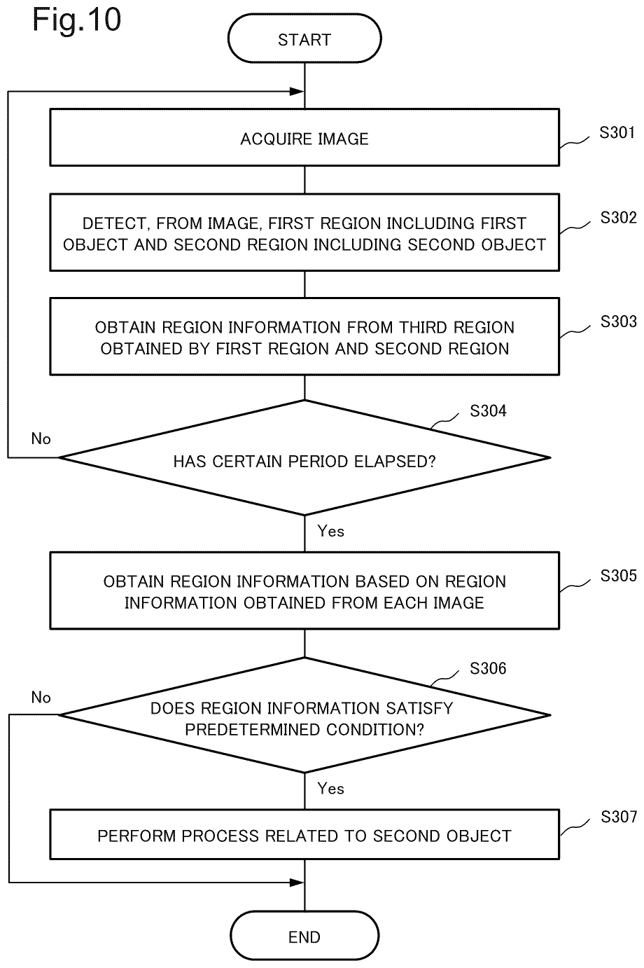

A series of processes performed by the information processing device 30 of the present example embodiment will be described with reference to a flowchart of FIG. 10. FIG. 10 is a flowchart illustrating the process performed by the information processing device 30 of the third example embodiment. Description of the process overlapping with that of the above-described example embodiment is partially omitted.

First, the information processing device 30 acquires the images 100 from various devices and obtains region information from the image 100 (S301 to S303). Thereafter, the information processing device 30 determines whether a certain period has elapsed (S304). The certain period may be, for example, a period from the start of the flow until the lapse of the certain period, or a period from the start of the flow and the acquisition of the first image until the lapse of the certain period. Alternatively, the measurement may be started with a specific process as a starting point.

Then, in a case where it is determined in S304 that the certain period has elapsed, the region analysis unit 33 obtains region information based on the region information obtained from each image (S305). For example, a value obtained by adding the first lengths 131 of the third region 130 is obtained. Other than this, a value obtained by adding the areas 133 of the third region may be obtained. On the other hand, when the certain period has not elapsed in S304, the process returns to S301, and the process of S301 to S303 is performed again.

Next, the information processing device 30 determines whether the region information satisfies a predetermined condition (S306). The predetermined condition is, for example, whether the sum of the first lengths 131 of the third region 130 is larger than a threshold value. Other than this, it may be determined that the sum of the areas 133 of the third region is larger than the threshold value. Then, in a case where it is determined in S306 that the region information satisfies the predetermined condition, the process related to the second object is performed (S307), and the flow ends. Examples of the process related to the second object include a process of identifying details of the second object, a process of making a notification related to the second object, and the like. On the other hand, in a case where it is determined that the region information does not satisfy the predetermined condition, the flow ends.

In the flowchart illustrated in FIG. 10, the process of S301 to S303 is repeated until it is determined in S304 that the certain period has elapsed, but the order of the processing is not limited thereto. For example, the process of acquiring an image (S301) may be performed until it is determined in S304 that a certain period has elapsed. Then, after it is determined that the certain period has elapsed, the region information about the third region 130 may be obtained from each of the acquired images (S302, S303). The process related to the second object may be performed in a case where a plurality of predetermined conditions is satisfied. Furthermore, the process related to the second object may be performed in a case where the predetermined condition is not satisfied.

According to such an information processing device 30, the region analysis unit 33 can obtain the region information based on the plurality of third regions 130 obtained from the plurality of images. As a result, the process related to the second object can be performed more accurately.

The third example embodiment in the present disclosure is not limited to the above-described aspect, but may be configured as follows, for example.

The information processing device 30 may be configured to perform a flow line analysis or the like on the object detected by the object detection unit 32. Then, whether the first object appearing in the image is the same as the first object appearing in another image may be determined based on the flow line. According to this, it is possible to identify whether the objects appearing in the plurality of images are the same object. Therefore, it is possible to suppress the addition of a third region 130 obtained by a first object different from a first object detected in the other image and a second object.

### Fourth Example Embodiment

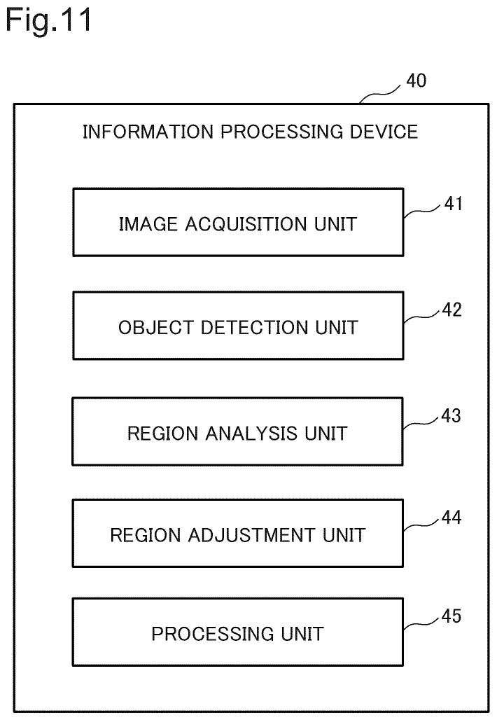

The fourth example embodiment of the present disclosure will be described with reference to FIGS. 11 to 13. The information processing device according to the present example embodiment is different from the information processing devices according to the first to third example embodiments in that it further includes a region adjustment unit.

FIG. 11 is a block diagram illustrating a configuration of an information processing device 40 according to the fourth example embodiment. The information processing device 40 includes an image acquisition unit 41, an object detection unit 42, a region analysis unit 43, a region adjustment unit 44, and a processing unit 45.

The region adjustment unit 44 corrects the third region 130 or the region information based on any of the information about the image, the information about the first object, and the information about the second object. The information about the image may include information about the device that has generated the image. The information about the device that has generated the image may include, for example, a position, the imaging direction, a depression angle, a magnification of the lens, and the like of the imaging device. The information about the first object may include a position of the first object on the image, an orientation of the first object, and the like. The information about the second object may include a position of the second object on the image, an orientation of the second object, and the like. Further, the information about the first object and the information about the second object may include information obtained in consideration of images acquired in the past. The information obtained in consideration of the images acquired in the past is, for example, the position of the first object and the position of the second object at a specific time. A flow line of the first object, a flow line of the second object, and the like may be included.

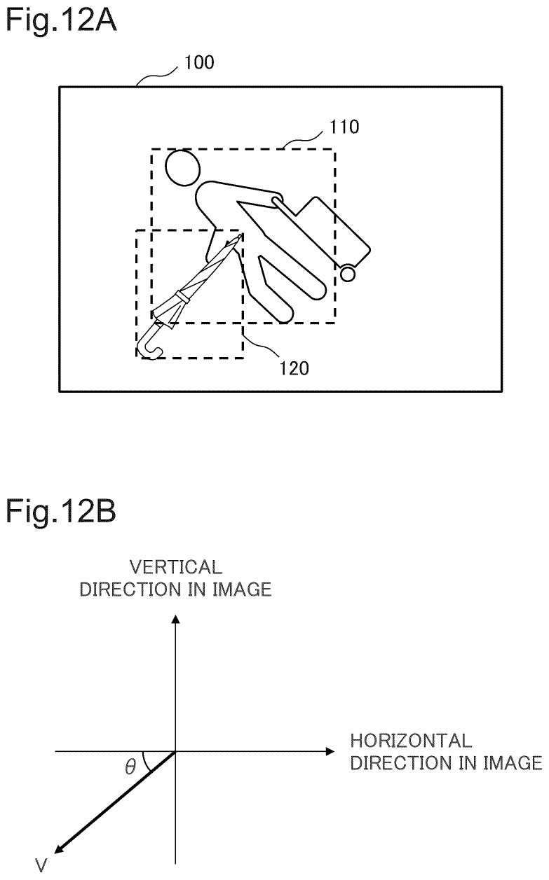

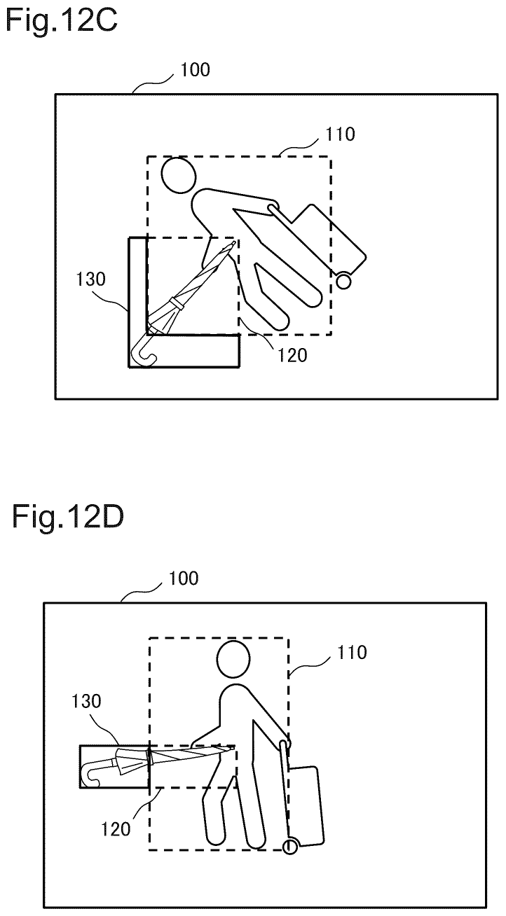

A method of correcting the third region 130 will be described with reference to FIGS. 12A to 12D. FIG. 12 is a diagram for describing a method of correcting the region information. FIG. 12A illustrates a state in which the first region 110 including the first object and the second region 120 including the second object are detected from the image 100.

The region adjustment unit 44 corrects the third region 130 based on the information about the image. The correction is performed using the moving direction of the first object. First, the region adjustment unit 44 acquires the moving direction of the first object appearing in the image 100. The moving direction of the first object may be obtained by analyzing a flow line or an optical flow of the first object. In a case where the first object is a person, the moving direction may be obtained by analyzing the line of sight of the person.

Then, an angle formed by the moving direction of the first object and the reference direction is obtained. As the reference direction, for example, a vertical direction or a horizontal direction in the image 100 may be used. The reference direction is described as the horizontal direction in the image 100. As a result, an angle formed by the moving direction V of the first object and the reference direction as illustrated in FIG. 12B is obtained. In this example, the angle formed by the moving direction of the first object and the reference direction is obtained, but instead of the moving direction of the first object, the angle formed by the moving direction of the second object and the reference direction may be obtained.

Next, the region adjustment unit 44 corrects the third region 130. For example, as illustrated in FIG. 12C, in the image 100, the third region 130 obtained by excluding a region overlapping the first region 110 in the second region 120 exists. In order to correct such a third region 130, each of the first region 110 and the second region 120 is multiplied by a predetermined function using an angle as an argument. Consequently, as illustrated in FIG. 12D, the corrected first region 110 and the corrected second region 120 are obtained. Then, in the corrected second region 120, the corrected third region 130 obtained by excluding a region overlapping the corrected first region 110 is obtained. As described above, the corrected third region 130 can be obtained.

In the above example, the method of correcting the third region 130 is described, but the region information may be corrected by a similar method. In the case of correcting the region information, the region information may be obtained from the third region 130 and may be multiplied by a predetermined function using an angle as an argument.

The method is not limited to a method of performing correction based on the moving direction of the first object or the second object described above, but the region adjustment unit 44 may perform correction by the following method. For example, in a case where correction is performed based on information about the device that has generated the image 100, a function using a position, an imaging direction, a depression angle, a magnification of the lens, and the like of the imaging device as arguments may be defined. Such a function may be, for example, for conversion into the size or position of the third region 130 obtained when the first object and the second object are imaged from a predetermined viewpoint or distance. Similarly, the region information may be corrected by such a method.

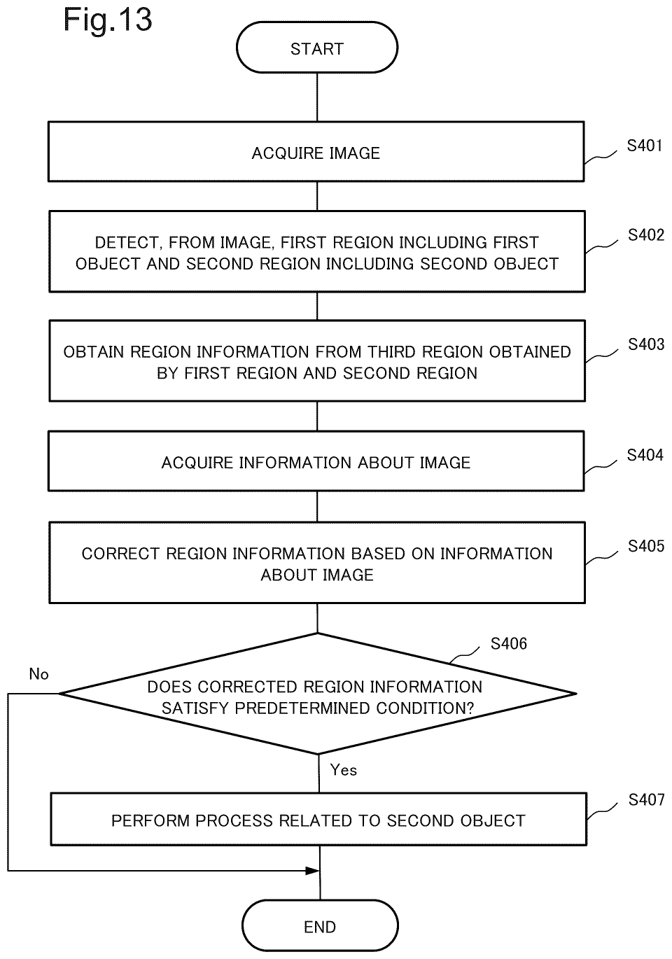

Next, a method of correcting the region information and performing the process related to the second object based on the corrected region information will be described with reference to FIG. 13. FIG. 13 is a flowchart illustrating a process performed by the information processing device 40 according to the fourth example embodiment. Description of the process overlapping with that of the above-described example embodiment is partially omitted.

The information processing device 40 acquires the images 100 from various devices and obtains region information from the image 100 (S401 to S403). The region adjustment unit 44 acquires information about the image (S404).

Next, the region adjustment unit 44 corrects the region information based on the acquired information about the image (S405). The region information corrected in this process is, for example, the first length 131 of the third region 130. Thereafter, the information processing device 40 determines whether the corrected region information satisfies a predetermined condition (S406). The predetermined condition is, for example, whether the first length 131 is larger than a threshold value.

In a case where it is determined in S406 that the predetermined condition is satisfied, the information processing device 40 performs a process related to the second object (S407), and the flow ends. Examples of the process related to the second object include a process of identifying details of the second object, a process of making a notification related to the second object, and the like. On the other hand, in a case where it is determined in S406 that the predetermined condition is not satisfied, the flow ends.

The processing order is not limited to a processing order illustrated in the flowchart illustrated in FIG. 13, but the region adjustment unit 44 may execute the process of acquiring the information about the image (S404) after acquiring the image 100 in S401. Similarly, part of the process of S405 may be executed prior to S402 or S403. Part of the process of S405 is a process of calculating a correction term based on information about an image, or the like. Furthermore, the region adjustment unit 44 may execute part of the process of S404 and S405 in parallel with the process of S402 and S403.

As described above, according to the configuration of the fourth example embodiment, the region adjustment unit 44 can correct the third region 130 or the region information based on any of the information about the image, the information about the first object, and the information about the second object. As a result, the accuracy of the process related to the second object can be further improved. In processing various images, the third region or the region information obtained from each image can be converted to satisfy the same criterion, so that it is possible to suppress the variation in the execution result of the process related to the second object from for each image.

### Fifth Example Embodiment

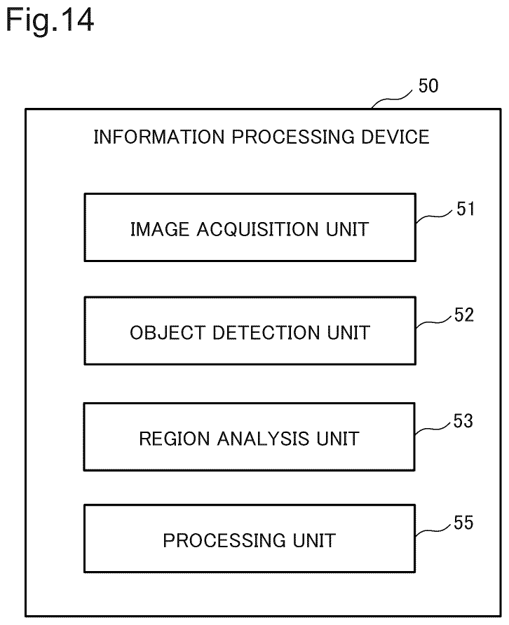

The fifth example embodiment of the present disclosure will be described with reference to FIGS. 14 to 16A to 16D. The information processing device of the present example embodiment is different from the information processing devices of the first to fourth example embodiments described above in that it includes a processing unit 55 to be described later instead of the processing units included in the information processing devices of the first to fourth example embodiments.

FIG. 14 is a block diagram illustrating a configuration of an information processing device 50 according to the fifth example embodiment. The information processing device 50 includes at least an image acquisition unit 51, an object detection unit 52, a region analysis unit 53, and the processing unit 55.

The processing unit 55 identifies details of the second object based on the third region 130 obtained by the first region 110 and the second region 120. In a case where the region information satisfies a predetermined condition, the processing unit 55 may be configured to identify details of the second object. The third region 130 is, for example, a region obtained by excluding a region in which the first region 110 and the second region 120 overlap each other, a region, of one region, overlapping with the other region in, or the like. More specifically, it is a region, of the second region 120, obtained by excluding a region overlapping with the first region 110. The details of the second object are not limited to, for example, the specific name of the second object, but may include a shape, a color, a size, and the like. The process of identifying the details of the second object may be achieved by using a detector adjusted to detect a specific object. For example, a detector for detecting a white cane is used.

The predetermined condition is, for example, that the first length 131 of the third region 130 is longer than a threshold value, that the second length 132 of the third region 130 is longer than a threshold value, or the like. The predetermined condition may further include that the area 133 of the third region is larger than the threshold value. Further, the predetermined condition may include that the third region 130 is present at a predetermined position. The predetermined position may be, for example, a specific position on the image, or may be represented by a relative positional relationship with the first object, such as “the third region 130 is located in front of the first object”. It may be determined whether results obtained by integrating, adding, subtracting, or averaging a plurality of pieces of region information satisfies various conditions as described above. The threshold value may be a common value or may be different for each determination.

The processing unit 55 may set a predetermined condition according to the type of the object whose details are desired to be identified. Furthermore, in a case where a predetermined condition is satisfied, detection regarding a specific object may not be performed. For example, in a case where the position information 134 of the third region 130 indicates that “the third region 130 is in front of and behind the first object”, a detector for detecting a white cane is not applied.

The detector may be configured by combining a plurality of detectors. In the case where the detector includes a plurality of detectors, a label may be given to a specific detector. The label is, for example, “walking aid” or “rain gear”.

The processing unit 55 may identify the details of the second object in consideration of reference information other than the region information. In the reference information, for example, in a case where the first object is a person, the attribute of the person may be treated as the reference information. The attribute of the person is information such as age, gender, and facial expression. As a result, in a case where the reference information indicating that the object is an elderly person is acquired from the image 100, it is possible to perform a process of preferentially applying a detector to which a label of the “walking aid” is given.

The reference information may include information about the environment acquired from the background of the image or the like. The information about the environment is, for example, information indicating the presence or absence of a place, facility, or equipment such as an intersection, a station yard, or a passage provided with a braille block. As a result, in a case where the reference information indicating that the second object exists around the braille block is acquired from the image 100, it is possible to perform a process of preferentially applying the detector to which the label of the “walking aid” is given.

Furthermore, the reference information may include information acquired from an external information providing device. Examples of the information acquired from such an external information providing device include information about weather and traffic. As a result, in a case where information such as rain and snow is acquired, it is possible to perform a process of preferentially applying a detector to which a label of the “walking aid” is given.

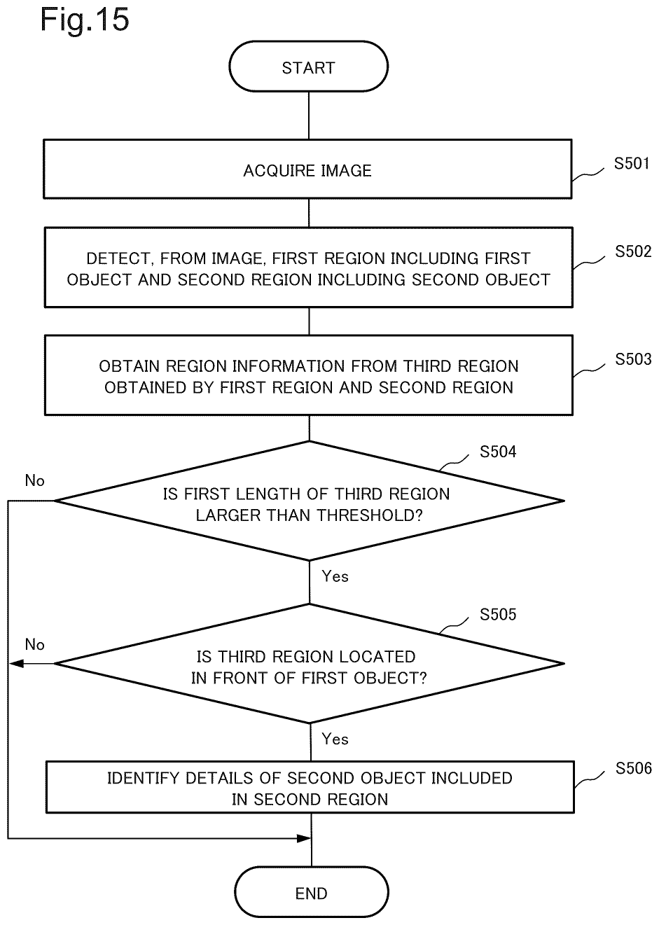

A series of processes performed by the information processing device 50 of the present example embodiment will be described with reference to a flowchart of FIG. 15. FIG. 15 is a flowchart illustrating a process performed by the information processing device 50 according to the fifth example embodiment. Description of the process overlapping with that of the above-described example embodiment is partially omitted.

The information processing device 50 acquires the images 100 from various devices and obtains region information from the image 100 (S501 to S503). Then, the processing unit 55 determines whether the first length 131 of the third region 130 is longer than a threshold value (S504).

When it is determined in S504 that the first length 131 is longer than the threshold value, the processing unit 55 further determines whether the third region 130 is present in front of the first object (S505). In a case where it is determined in S505 that the third region 130 is present in front of the first object, the processing unit 55 performs a process of identifying details of the second object (S506), and the flow ends. On the other hand, in a case where it is determined in S504 that the first length 131 is not longer than the threshold value, the flow ends. When it is determined in S505 that the third region 130 is not present in front of the first object, the flow ends.

In the flow illustrated in FIG. 15, it is determined in S504 and S505 whether the third region 130 satisfies each of the predetermined conditions, but only one predetermined condition may be determined. Details of the second object may be identified in a case where it is determined that the third region 130 does not satisfy the predetermined condition.

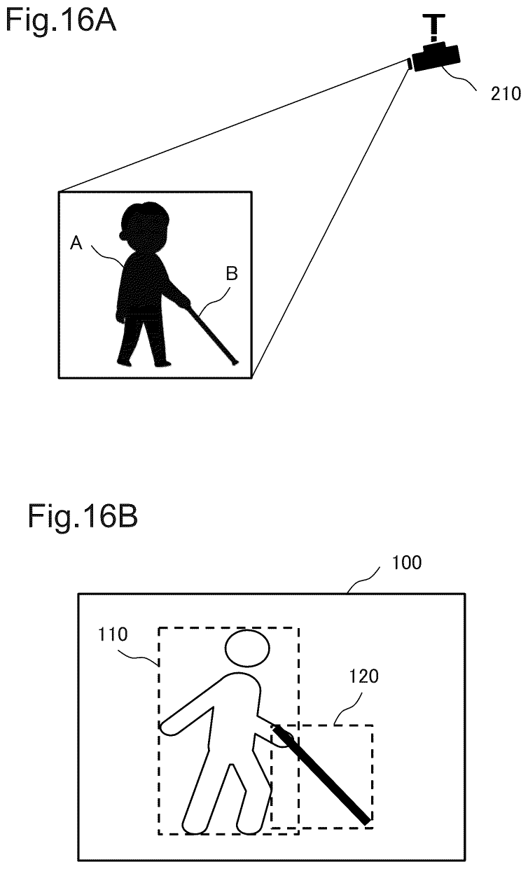

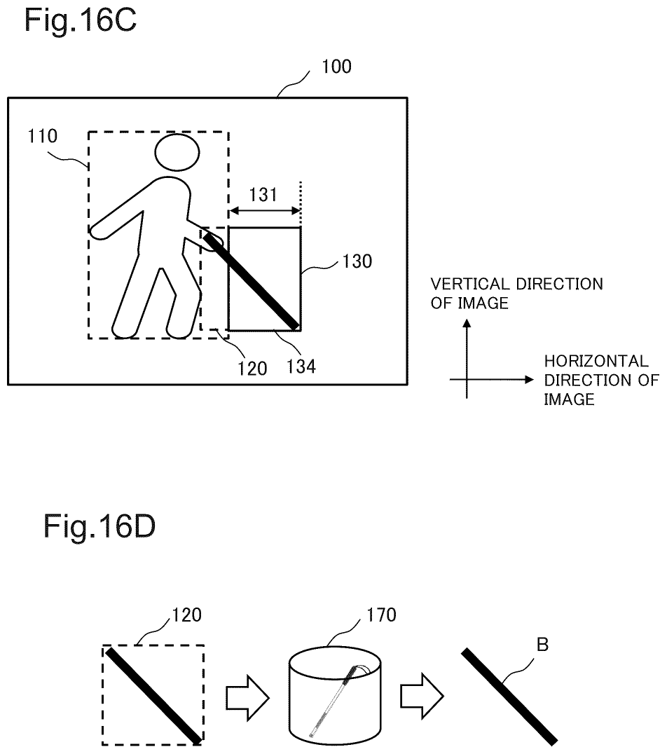

Next, a usage example of the information processing device 50 of the present example embodiment will be described with reference to FIGS. 16A to 16D. FIGS. 16A to 16D are diagrams for explaining the usage example of the information processing device 50. In the use example described here, as illustrated in FIG. 16A, a situation in which a monitoring camera 210 captures a person A carrying a white cane B will be assumed. The image acquisition unit 51 cooperates with the monitoring camera 210 to acquire the image 100. Then, the object detection unit 52 detects the first region 110 including the first object and the second region 120 including the second object from the image 100. As a result, the first region 110 and the second region 120 as illustrated in FIG. 16B are detected.

Next, the region analysis unit 53 obtains region information based on the third region 130 obtained by the first region 110 and the second region 120. As illustrated in FIG. 16C, the third region 130 in this usage example is a region obtained by excluding a region overlapping the first region 110 in the second region 120. The region information in this usage example is the first length 131 and the position information 134 of the third region 130. Furthermore, the first length 131 in this usage example is a length that is the longest among the lengths, of the third region 130, in the direction along the horizontal direction of the image 100.

Then, the processing unit 55 determines whether the third region 130 satisfies a predetermined condition based on the region information obtained by the region analysis unit 53. The predetermined information in this usage example is that the first length 131 is longer than the threshold value, and the position information 134 is located in front of the first object. As a result of the determination, since the third region 130 satisfies the predetermined condition, the processing unit 55 identifies details of the second object. FIG. 16D illustrates how a detector 350 for detecting the white cane B identifies that the second object included in the second region 120 is the white cane B. As a result, the information processing device 50 identifies that the monitoring camera 210 has captured the white cane.

As described above, according to the information processing device 50 of the present example embodiment, the processing unit 55 identifies the details of the second object based on the third region 130. This makes it possible to efficiently perform a process of identifying details of the object.

The fifth example embodiment in the present disclosure is not limited to the above-described aspect, but may be configured as follows, for example.

The information processing device 50 may be configured to consider the region information about the second region 120. The region information about the second region 120 may include values equivalent to various values that can be obtained by the region analysis unit 53. For example, it may include the first length, the second length, the aspect ratio, and the like of the second region 120. Then, for example, in a case where the aspect ratio of the second region 120 falls within a specific range, the information processing device 50 may perform a process of identifying details regarding the second object. Other than this, in a case where the aspect ratio of the second region 120 is larger or smaller than the threshold value, details regarding the second object may be identified. Such determination based on the region information about the second region 120 may be performed after it is determined whether the region information about the third region 130 satisfies a predetermined condition. Before it is determined whether the region information about the third region 130 satisfies a predetermined condition, the determination based on the region information about the second region 120 may be performed. According to this, it is possible to further improve the efficiency of the process of identifying details regarding the second object.

### Sixth Example Embodiment

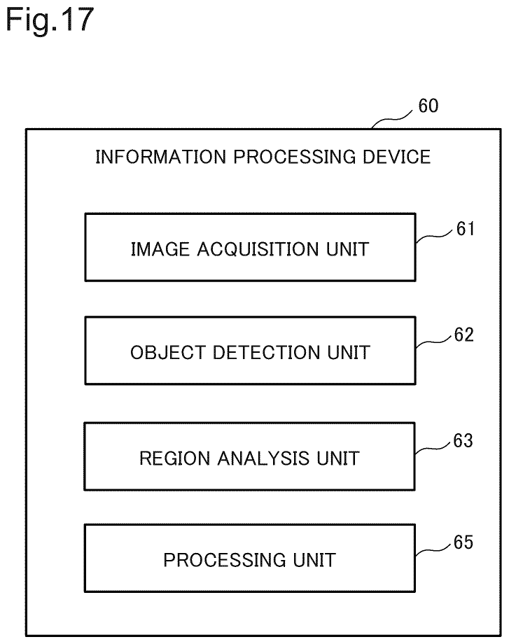

The sixth example embodiment of the present disclosure will be described with reference to FIGS. 17 to 19A to 19D. The information processing device of the present example embodiment is different from the information processing devices of the first to fifth example embodiments described above in that it includes a processing unit 65 to be described later instead of the processing units included in the information processing devices of the first to fifth example embodiments described above.

FIG. 17 is a block diagram illustrating a configuration of an information processing device 60 according to the sixth example embodiment. The information processing device 60 includes at least an image acquisition unit 61, an object detection unit 62, a region analysis unit 63, and the processing unit 65.

The processing unit 65 makes a notification regarding the second object based on the third region 130 obtained by the first region 110 and the second region 120. In a case where the region information satisfies a predetermined condition, the processing unit may be configured to identify details of the second object. The third region 130 is, for example, a region obtained by excluding a region in which the first region 110 and the second region 120 overlap each other, a region, of one region, overlapping with the other region in, or the like. More specifically, it is a region, of the second region 120, obtained by excluding a region overlapping with the first region 110. The notification related to the second object includes various notifications, for example, attention calling, support request, and the like. The target to whom the notification is to be made is a person detected as the first object, a person around the device that has acquired the image 100, or the like. In addition, notification may be made to a person in a remote place such as a monitoring center.

The predetermined condition is, for example, that the first length 131 of the third region 130 is longer than a threshold value, that the second length 132 of the third region 130 is longer than a threshold value, or the like. The predetermined condition may further include that the area 133 of the third region is larger than the threshold value. Further, the predetermined condition may include that the third region 130 is present at a predetermined position. The predetermined position may be, for example, a specific position on the image, or may be represented by a relative positional relationship with the first object, such as “the third region 130 is located in front of the first object”. It may be determined whether results obtained by integrating, adding, subtracting, or averaging a plurality of pieces of region information satisfies various conditions as described above. The threshold value may be a common value or may be different for each determination.

The processing unit 65 may change the content of the notification related to the second object according to the third region 130. Examples of the content of the notification include a length, the number of times, a frequency, an interval, and the like of the notification.

For example, in a case where it is determined that the second object is likely to harm the surroundings based on the region information, the processing unit 65 may make a notification. For example, in a case where the region information satisfies a predetermined condition, it may be determined that the object is likely to harm the surroundings. For example, in a case where the first length 131 of the third region 130 is longer than a threshold value, it is determined that the object is likely to harm the surroundings.

In addition to the predetermined condition, an index value such as the degree of congestion may be considered. For example, it is easily determined that the object is likely to harm the surroundings as the congestion degree indicates congestion. The degree of congestion may be calculated based on the number of persons appearing in the image 100, or the degree of congestion calculated by another device may be used. In order to make it easier to determine that the object is likely to harm the surroundings, the value of the threshold value used at the time of determination under a predetermined condition may be reduced.

Furthermore, a flow line of the first object or the second object may be considered. For example, the content of the notification, the condition for making the notification, and the target to whom the notification is to be made may be changed between a case where the third region 130 exists in the traveling direction of the first object and a case where the third region 130 exists in the direction intersecting the traveling direction of the first object. For example, in a case where a second object is present behind the first object, attention is called to the first object, and in a case where a second object is present beside the first object, attention is called to a person around the device that has generated the image 100.

The processing unit 65 may make a notification regarding the second object via various notification devices. The various notification devices are, for example, an audio output device such as a speaker or a display device such as a display. The notification device may be installed in a specific place such as a road, a facility, or a monitoring center, or may be a mobile or portable device. Furthermore, the device may have directivity to transmit information only to a specific person. The various notification devices and the information processing device 60 may be integrally configured.

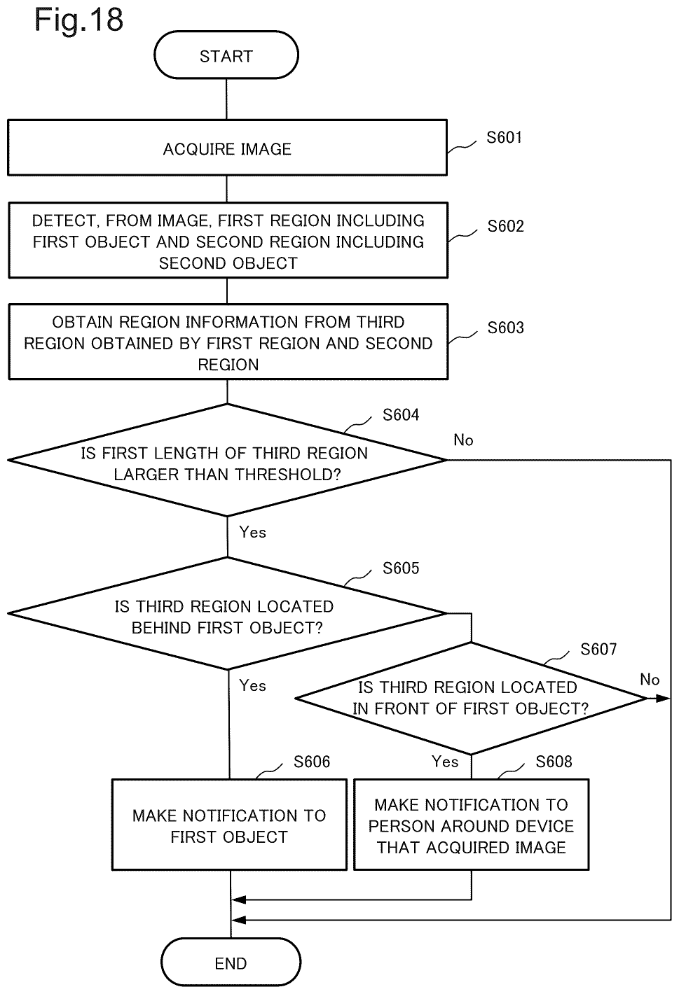

A series of processes performed by the information processing device 60 of the present example embodiment will be described with reference to a flowchart of FIG. 18. FIG. 18 is a flowchart illustrating a process performed by the information processing device 60 according to the sixth example embodiment. Description of the process overlapping with that of the above-described example embodiment is partially omitted.

The information processing device 60 obtains region information from the images 100 acquired from various devices (S601 to S603). Then, the processing unit 65 determines whether the first length 131 of the third region 130 is longer than a threshold value based on the region information acquired by the information processing device 60 (S604).

When it is determined in S604 that the first length 131 is longer than the threshold value, the processing unit 65 further determines whether the third region 130 is behind the first object (S605). In a case where it is determined in S605 that the third region 130 is behind the first object, the processing unit 65 makes a notification to the first object (S606), and the flow ends. The notification directed to the first object prompts improvement of manners, for example, “you may cause a danger to the surroundings”.

On the other hand, when it is determined in S605 that the third region 130 is not present behind the first object, the processing unit 65 further determines whether the third region 130 is present in front of the first object (S607). Then, in a case where it is determined in S607 that the third region 130 is present in front of the first object, the processing unit 65 makes a notification to a person around the device that has acquired the image 100 (S608), and the flow ends. The notification to a person around the device that has acquired the image 100 prompts avoidance of danger, for example, “there is a danger nearby”. On the other hand, in a case where it is determined in S604 or S607 that the condition is not satisfied, the flow ends without making the notification.

In the flow illustrated in FIG. 18, it is determined whether a plurality of predetermined conditions is satisfied for the third region 130, but one predetermined condition to be determined may be used. In a case where it is determined that the third region 130 does not satisfy the condition, a notification may be made.

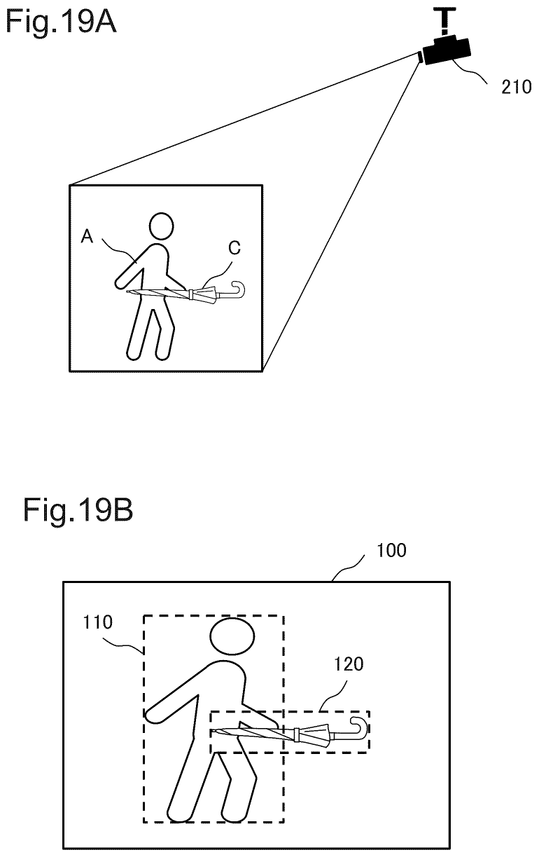

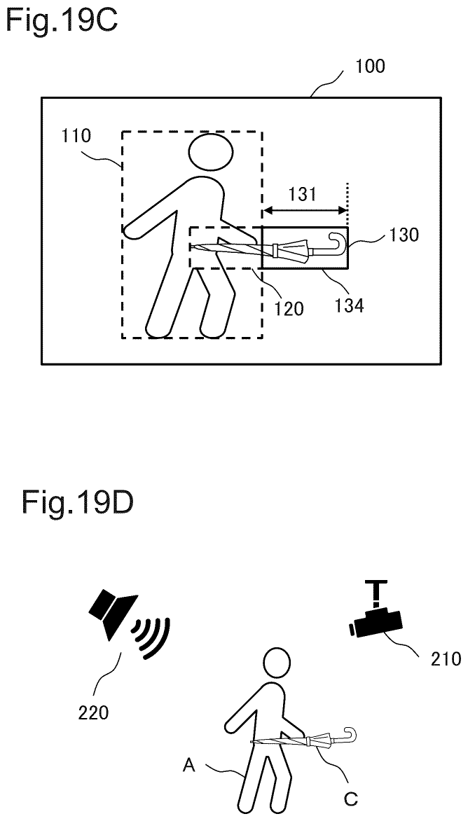

Next, a usage example of the information processing device 60 of the present example embodiment will be described with reference to FIGS. 19A to 19D. FIGS. 19A to 19D are diagrams for explaining the usage example of the information processing device 60. In the use example described here, as illustrated in FIG. 19A, a situation in which the monitoring camera 210 captures the person A carrying an umbrella C will be assumed. Image acquisition unit 61 cooperates with monitoring camera 210 to acquire the image 100. Then, the object detection unit 62 detects the first region 110 including the first object and the second region 120 including the second object from the image 100. As a result, the first region 110 and the second region 120 as illustrated in FIG. 19B are detected.

Next, the region analysis unit 53 obtains region information based on the third region 130 obtained by the first region 110 and the second region 120. As illustrated in FIG. 19C, the third region 130 in this usage example is a region obtained by excluding a region, of second region 120, overlapping first region 110. The region information in this usage example is the first length 131 and the position information 134 of the third region 130. Furthermore, the first length 131 in this usage example is a length that is the longest among the lengths, of the third region 130, in the direction along the horizontal direction of the image 100.

Then, the processing unit 65 determines whether the third region 130 satisfies a predetermined condition based on the region information obtained by the region analysis unit 63. The predetermined condition in this use example is that the first length 131 is longer than the threshold value and that the position information 134 is located in front of the first object. As a result of the determination, since the predetermined condition is satisfied, as illustrated in FIG. 19D, the information processing device 60 makes a notification related to the second object a speaker 220 installed around the monitoring camera 210.

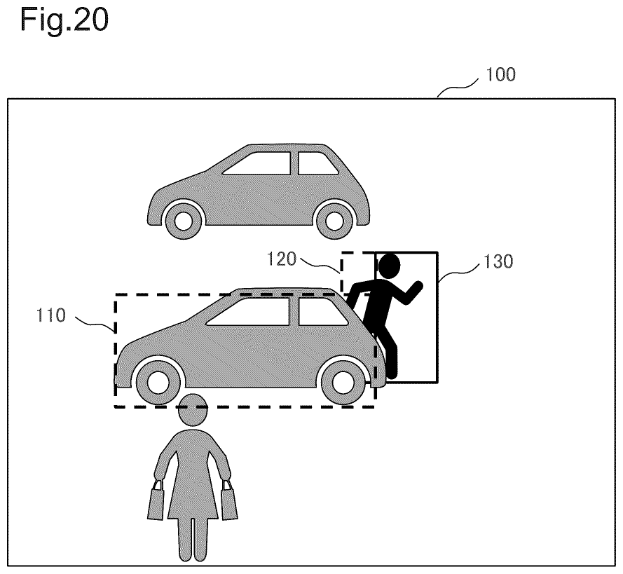

In the use example illustrated in FIGS. 19A to 19D, the person A is detected as the first object, and the umbrella C is detected as the second object, but the first object may be an object other than the person. As an example, a use method as illustrated in FIG. 20 is also conceivable. FIG. 20 is a diagram for describing another usage example of the information processing device 60 of the sixth example embodiment. FIG. 20 illustrates a state in which the first region 110 including a vehicle as the first object is detected, and the second region 120 including a person as the second object is detected from the image 100. In such a case, for example, since the third region 130 is detected in a case where a person runs out of the vehicle, it can be used to make various notifications such as calling attention.

As described above, according to the information processing device 60 of the present example embodiment, the processing unit 65 can make a notification related to the second object based on the third region 130. As a result, notification regarding the second object can be efficiently made.

The sixth example embodiment in the present disclosure is not limited to the above-described aspect, but may be configured as follows, for example.

The information processing device 60 may make a notification to a person registered in advance. For example, in a case where the processing unit 65 determines to make a notification, the information processing device 60 makes a notification to a person registered in advance. Notification may be made only to a person satisfying the notification condition from among persons registered in advance.

For example, in a case where the processing unit 65 determines to make a notification based on the image 100, the notification condition may include a condition that the object is present around the device that has generated the image 100. The process of identifying the person registered in advance may be performed in cooperation with the monitoring camera 210 and may be identified by a known face authentication technique. Furthermore, not only the face authentication but also various techniques utilizing position information such as geofencing may be used to identify whether a person registered in advance is present in a surrounding area of the device that has generated the image 100.

The information processing device 60 may store information about the first object or the second object detected when the processing unit 65 determines to make a notification in association with information about the notification. The information about the notification may include a notification date and time, a notification content, a notification method, and the like. Furthermore, in a case of notifying the same object that has already been stored, the processing unit 65 may make a notification using a method different from a method of a notification made in the past. For example, when it is determined that it is necessary to call attention to a specific person, in a case where there is a history of calling attention to the person through a speaker in the past, various notification devices are used instead of calling attention by the speaker, for example, the security guard in the vicinity is requested to call attention.

The processing unit 65 may make a notification regarding the second object in consideration of details of the first object or the second object. More specifically, the content of the notification, the condition for making the notification, and the target to whom the notification is to be made may be changed according to the details of the first object or the second object. For example, different notifications are made between a person who walks with an umbrella protruding forward and a person who walks with a white cane protruding forward. Details of the object are not limited to, for example, a specific name of the object, but may include a shape, a color, a size, and the like. The details of the object may be identified using the detector described above, or may be obtained by another method. According to this, a more detailed notification regarding the second object can be made.

(Hardware Configuration)

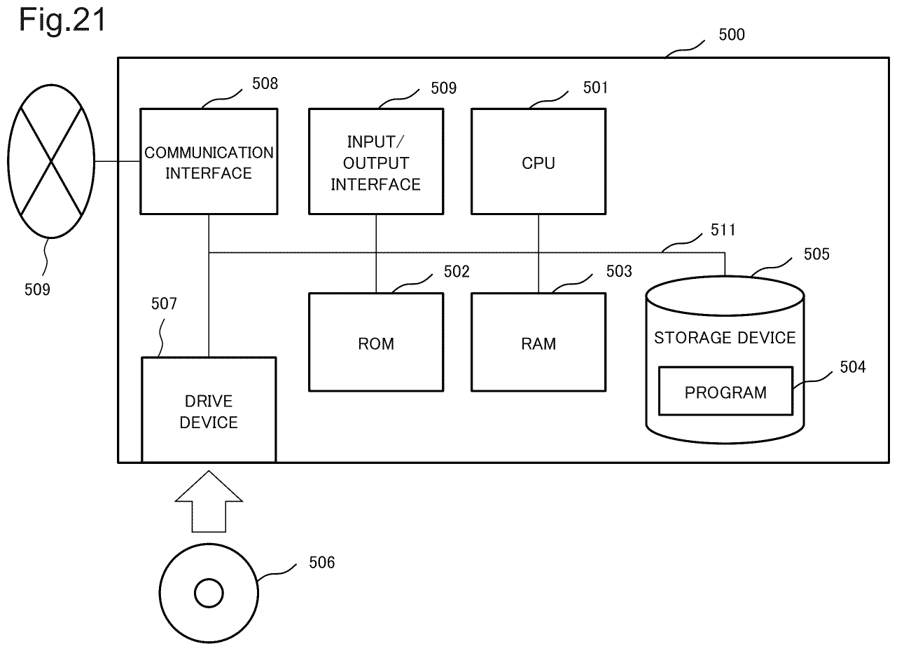

In each example embodiment of the present disclosure, each component of each device indicates a block of a functional unit. Part or all of each component of each device is achieved by, for example, an any combination of an information processing device 500 and a program as illustrated in FIG. 21. FIG. 21 is a block diagram illustrating an example of a hardware configuration of the information processing device 500 that achieves each component of each device. The information processing device 500 includes the following configuration as an example.
CPU (Central Processing Unit) 501
ROM (Read Only Memory) 502
RAM (Random Access Memory) 503
program 504 loaded into RAM 503
storage device 505 storing program 504
drive device 507 that reads and writes recording medium 506
communication interface 508 connected with a communication network 509
input/output interface 510 for inputting/outputting data
bus 511 connecting each component

Each component of each device in respective example embodiments is achieved by the CPU 501 acquiring and executing the program 504 for achieving these functions. More specifically, the CPU 501 is implemented by executing various programs such as a program for acquiring the image 100, a program for detecting the first region 110 including the first object and the second region 120 including the second object from the image 100, and a program for executing a process related to the second object based on the third region 130 obtained by the first region 110 and the second region 120, and performing an update process of various parameters held in the RAM 503, the storage device 505, and the like.

The program 504 for achieving the function of each component of each device is stored in the storage device 505 or the ROM 502 in advance, for example, and is read by the CPU 501 as necessary. The program 504 may be supplied to the CPU 501 via the communication network 509. The drive device 507 may read a program stored in advance in the recording medium 506 and supply the program to the CPU 501.

The program 504 can display the progress of the process or the processing result via the output device. Furthermore, it is possible to communicate with an external device via a communication interface. The program 504 can be recorded in a computer-readable (non-transitory) storage medium.

Each device is not limited to having the above-described configuration, but can be achieved by various configurations. For example, each device may be achieved by combining, in any manner, the information processing devices 500 and the programs 504 each of which is different in respective configurations. A plurality of components included in each device may be achieved by an any combination of one information processing device 500 and the programs 504.

Part or all of each component of each device is achieved by another general-purpose or dedicated circuit, processor, or the like, or a combination thereof. These may be configured by a single chip or may be configured by a plurality of chips connected via a bus 511.

Part or all of each component of each device may be achieved by a combination of the above-described circuit or the like and the program.

In a case where part or all of each component of each device is achieved by a plurality of information processing devices, circuits, and the like, the plurality of information processing devices, circuits, and the like may be disposed in a centralized manner or in a distributed manner. For example, the information processing device, the circuit, and the like may be achieved as a form of an information processing system in which a client and server system, a cloud computing system and the like are connected to each other via the communication network 509.

In a case where they are achieved as the form of the information processing system, for example, one or a plurality of information processing devices may include an image acquisition means configured to acquire the image 100, an object detection means configured to detect the first region 110 including the first object and the second region 120 including the second object from the image 100, and a processing means configured to perform a process related to the second object based on the third region 130 obtained by the first region 110 and the second region 120. Not limited thereto, part or all of the image acquisition means, the object detection means, and the processing means may be configured as an imaging device, a display device, an edge terminal, or the like. For example, the image acquisition means is configured as the imaging device, the object detection means is configured as the information processing device 500, and the processing means is configured as the display device. Then, the imaging device, the information processing device 500, and the display device may be connected by using the communication network 509, the bus 511, or the like to be achieved as the information processing system.

Each of the above-described example embodiments is a preferred example embodiment of the present disclosure, and the scope of the present disclosure is not limited only to each of the above-described example embodiments. That is, it is possible for those skilled in the art to make modifications and substitutions of the above-described example embodiments without departing from the gist of the present disclosure, and to construct a mode in which various modifications are made.

Some or all of the above example embodiments may be described as the following Supplementary Notes, but are not limited to the following.

### Supplementary Note 1

An information processing device including
an image acquisition unit that acquires an image,
an object detection unit that detects a first region including a first object and a second region including a second object from the image, and
a processing unit that performs a process related to the second object based on a third region obtained by the first region and the second region.

### Supplementary Note 2

The information processing device according to Supplementary Note 1, wherein
the third region is a region, of the second region, obtained by excluding a region overlapping the first region.

### Supplementary Note 3

The information processing device according to Supplementary Note 1 or 2, wherein
the information processing device includes a region analysis unit that obtains region information from the third region.

### Supplementary Note 4

The information processing device according to Supplementary Note 3, wherein
the region information includes a length of the third region, and wherein the processing unit performs a process related to the second object based on the length of the third region.

### Supplementary Note 5

The information processing device according to Supplementary Note 4, wherein
the information processing device obtains at least one of a first length along a first direction or a second length along a second direction orthogonal to the first direction of the third region as a length of the third region.

### Supplementary Note 6

The information processing device according to Supplementary Note 5, wherein
the processing unit performs a process related to the second object in a case where the first length is longer than a threshold.

### Supplementary Note 7

The information processing device according to any one of Supplementary Notes 3 to 6, wherein
the region analysis unit obtains an area of the third region, and wherein
the processing unit performs a process related to the second object based on an area of the third region.

### Supplementary Note 8

The information processing device according to Supplementary Note 7, wherein
the processing unit performs a process related to the second object in a case where the area of the third region is larger than a threshold value.

### Supplementary Note 9

The information processing device according to any one of Supplementary Notes 3 to 8, wherein
the region analysis unit obtains position information about the third region, and wherein
the processing unit performs a process related to the second object based on the position information about the third region.

### Supplementary Note 10

The information processing device according to Supplementary Note 9, wherein
the region analysis unit obtains position information about the third region based on a position of the first object on an image or an orientation of the first object.

### Supplementary Note 11

The information processing device according to Supplementary Note 10, wherein
the processing unit performs a process related to the second object in a case where the third region is present at a predetermined position.

### Supplementary Note 12

The information processing device according to any one of Supplementary Notes 3 to 11, wherein
the region analysis unit obtains the region information based on a plurality of the third regions obtained from a plurality of images.

### Supplementary Note 13

The information processing device according to Supplementary Note 12, wherein
the plurality of images is images obtained during a certain period of time.

### Supplementary Note 14

The information processing device according to any one of Supplementary Notes 1 to 13, wherein
the information processing device includes a region adjustment unit that corrects the third region based on any of information about the image, information about the first object, and information about the second object.

### Supplementary Note 15

The information processing device according to any one of Supplementary Notes 3 to 14, wherein
the information processing device includes a region adjustment unit that corrects the region information based on any of information about the image, information about the first object, and information about the second object.

### Supplementary Note 16

The information processing device according to Supplementary Note 14, wherein
the region adjustment unit corrects the first region and the second region based on information about the image, and
obtains the third region based on the corrected first region and the corrected second region.

### Supplementary Note 17

The information processing device according to any one of Supplementary Notes 3 to 16, wherein
the processing unit identifies details of the second object in a case where the region information satisfies a predetermined condition.

### Supplementary Note 18

The information processing device according to any one of Supplementary Notes 3 to 16, wherein
the processing unit makes a notification related to the second object in a case where the region information satisfies a predetermined condition.

### Supplementary Note 19

An information processing system including
an image acquisition means configured to acquire an image,
an object detection means configured to detect a first region including a first object and a second region including a second object from the image, and
a processing means configured to perform a process related to the second object based on a third region obtained by the first region and the second region.

### Supplementary Note 20

An information processing method including acquiring an image,
detecting a first region including a first object and a second region including a second object from the image, and
performing a process related to the second object based on a third region obtained by the first region and the second region.

The forms of the Supplementary Notes 19 to 20 can be expanded to the forms of the Supplementary Notes 2 to 18, as in the Supplementary Note 1.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An information processing device comprising:
a memory that stores an instruction; and
one or more processors that execute, in accordance with the instruction,
acquiring an image,
detecting a first region including a first object and a second region including a second object from the image, and
a process related to the second object based on a third region obtained by the first region and the second region.

2. The information processing device according to claim 1, wherein
the one or more processors further execute
obtaining region information from the third region.

3. The information processing device according to claim 2, wherein
the region information includes a length of the third region, and wherein
the one or more processors execute
a process related to the second object based on the length of the third region.

4. The information processing device according to claim 2, wherein
the one or more processors execute
obtaining position information about the third region, and
a process related to the second object based on the position information about the third region.

5. The information processing device according to claim 2, wherein
the one or more processors execute
obtaining the region information based on a plurality of the third regions obtained from a plurality of images.

6. The information processing device according to claim 1, wherein
the one or more processors further execute
correcting the third region based on any of information about the image, information about the first object, and information about the second object.

7. The information processing device according to claim 2, wherein
the one or more processors execute
a process of identifying details of the second object in a case where the region information satisfies a predetermined condition.

8. The information processing device according to claim 2, wherein
the one or more processors execute
making a notification related to the second object in a case where the region information satisfies a predetermined condition.

9. A non-transitory recording medium storing a program for causing a computer to execute:
a step of acquiring an image;
a step of detecting a first region including a first object and a second region including a second object from the image; and
a step of performing a process related to the second object based on a third region obtained by the first region and the second region.

10. The recording medium according to claim 9, wherein
the program causes the computer to further execute
a step of obtaining region information from the third region.

11. The recording medium according to claim 10, wherein
the region information includes a length of the third region, and wherein
the program causes the computer to execute
a step of performing a process related to the second object based on the length of the third region.

12. The recording medium according to claim 10, wherein
the program causes the computer to execute
a step of obtaining position information about the third region, and
a step of performing a process related to the second object based on the position information about the third region.

13. The recording medium according to claim 10, wherein
the program causes the computer to execute
a step of obtaining the region information based on a plurality of the third regions obtained from a plurality of images.

14. The recording medium according to claim 9, wherein
the program causes the computer to further execute
a step of correcting the third region based on any of information about the image, information about the first object, and information about the second object.

15. An information processing method comprising:
acquiring an image;
detecting a first region including a first object and a second region including a second object from the image; and
performing a process related to the second object based on a third region obtained by the first region and the second region.

16. The information processing method according to claim 15, further comprising:
performing a process of obtaining region information from the third region.

17. The information processing method according to claim 16, wherein
the region information includes a length of the third region, and wherein
the method includes performing a process related to the second object based on the length of the third region.

18. The information processing method according to claim 16, wherein
the method includes
performing a process of obtaining position information about the third region, and
a process related to the second object based on position information about the third region.

19. The information processing method according to claim 16, wherein
the method includes performing a process of obtaining the region information based on a plurality of the third regions obtained from a plurality of images.

20. The information processing method according to claim 15, further comprising:
performing a process of correcting the third region based on any of the information about the image, the information about the first object, and the information about the second object.
